(19) United States
(12) Patent Application Publication
(10) Pub. No.: US 2008/0312031 A1
(43) Pub. Date: Dec. 18, 2008

(54) Method for Controlling the Mechanical Drive Train System of a Motor Vehicle

(75) Inventor: Ulrich Reith, Schlier (DE)

Correspondence Address: DAVIS BUJOLD & Daniels, P.L.L.C., 112 PLEASANT STREET, CONCORD, NH, 03301, US

(73) Assignee: ZF Friedrichshafen AG, Friedrichshafen (DE)

(21) Appl. No.: 12/093,349

(22) PCT Filed: Nov. 10, 2006
(86) PCT No.: PCT/EP2006/010773

§ 371 Date: Aug. 13, 2008

(30) Foreign Application Priority Data
Nov. 12, 2005 (DE) 10 2005 039 930.4

(51) Int. Cl. B60W 10/10

(52) U.S. Cl. 477/92

(57) ABSTRACT

A method of controlling a mechanical drive train (2, 4, 6, 8) of a motor vehicle having an automatic or automated transmission (6) and a stabilization system (16) that acts on the wheels (14) of the vehicle. The stabilization system including an electronic vehicle control device (18), which shifts the transmission (6) depending on the standard drive states detected by sensors. The stabilization system (16) is controlled by alternative control program, if a non-standard drive state is detected which would prevent intervention of the stabilization system, such that a drive train configuration is established that would permit the intervention

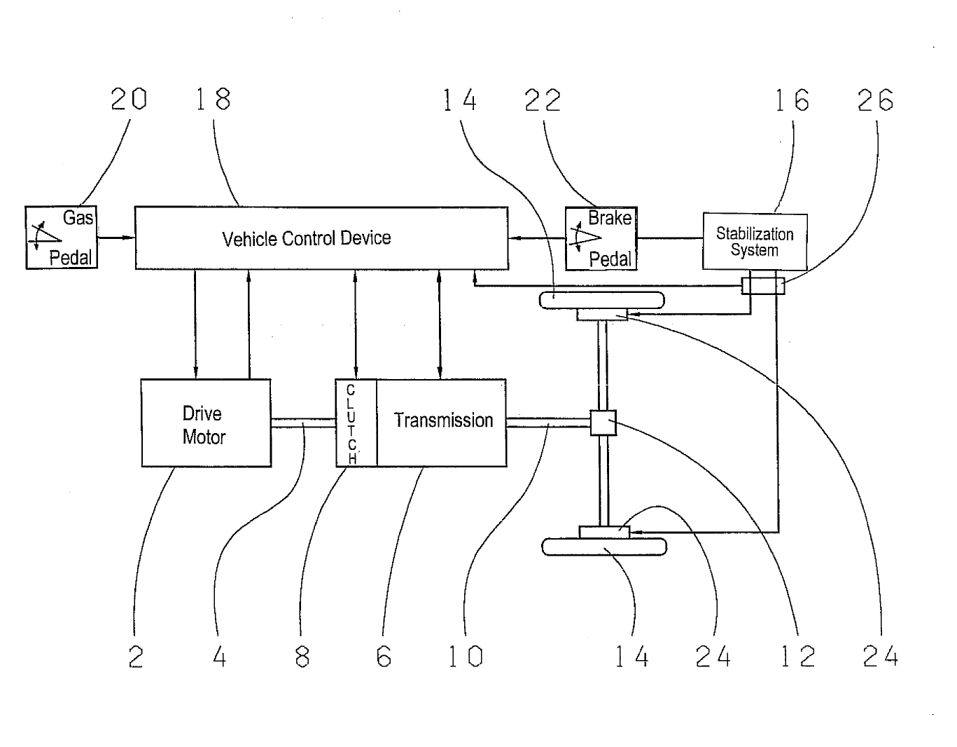

This application is a national stage completion of PCT/EP2006/010773 filed Nov. 10, 2006, which claims priority from German Application Serial No. 10 2005 039 930.4 filed Nov. 12, 2005.

### FIELD OF THE INVENTION

The invention relates to a method of controlling the mechanical drive train system of a motor vehicle having an automatic or automated transmission, in conjunction with a stabilization system that acts on the wheels of the vehicle. The system comprising an electronic vehicle control device, by way of which the transmission is shifted as a function of standard driving states detected by sensors, and by way of which, for example, the stabilization system is controlled when non-standard driving states occur, whereby in the case of standard driving states on the one hand, and non-standard driving states on the other hand, different control programs for controlling the drive train system are used.

### BACKGROUND OF THE INVENTION

In the case of automatic transmissions, a gear change takes place, which is to say the clutch is released and engaged, the transmission is shifted and, if necessary, the rotational speed of the drive motor is controlled for the purpose of synchronization in a fully automatic manner, as a function of the standard driving states detected by way of sensors. In the case of automated transmissions, the driver can pre-select a desired gear. The actual gear change then likewise takes place fully automatically.

The term “stabilization system” will be used below in the sense of any system in the motor vehicle that acts on the wheels of the vehicle during non-standard driving states. In this sense, an ABS (anti-lock breaking system) can be understood as the simplest stabilization system; the system preventing the locking of individual wheels while braking, thereby preserving steerability and driving stability and optimizing the braking distance. Additional stabilization systems include ASR (traction control system), EBS (electronically controlled brake system), which electronically controls ABS- and ASR-functions and combines them into a system, as well as more highly developed driving dynamics systems with roll, pitch, and yaw control (VDC=vehicle dynamic stability control) and similar systems.

In general, it cannot be ruled out that a transmission shifting operation and activation of the stabilization system will take place simultaneously. However, there are situations in which it is disadvantageous if the torque in the drive train is changed, for example due to disengaging an engaged drive train or the engaging the disengaged drive train or due to the action of additional brakes or auxiliary drive units on the drive train or similar control actions. For example, if the drive train is disengaged during the transmission-shifting operation, torque fluctuations are produced in the drive train that have a disadvantageous effect on the mode of operation of a simultaneous braking intervention of an automatic braking system (for example EBS).

Against this background, the object of the invention is to create a method of controlling the mechanical drive train system of a motor vehicle such that torque fluctuations in the drive train are avoided during driving states in which the fluctuations would have a disadvantageous effect on the function of the stabilization system.

### SUMMARY OF THE INVENTION

The invention is based on the realization that it should be possible to identify driving states of this kind by way of a vehicle control device and, when such driving states occur, to prevent shifting and control measures that result in torque fluctuation in the drive train.

From U.S. Pat. No. 4,899,279, a method for controlling the mechanical drive train (AMT-system=automatic mechanical transmission system) of a motor vehicle with an automatic or automated transmission is known in connection with an anti-lock brake system wherein, when a wheel-locking situation occurs, an intervention occurs in the configuration of the drive train. With this known control method, a wheel-locking situation is detected by way of sensors arranged on the braked wheels and the drive train is then disengaged by disengaging the clutch in order to uncouple the transmission and the drive motor from the wheels so that when the locked wheels are accelerated to the rotational speed corresponding to the speed of the vehicle, the decelerating effect of the mass inertia of the transmission and motor is eliminated.

As already described above, however, there is the risk that changes in torque in the drive train from disengaging the same during the intervention of a stabilization system, will have a disadvantageous effect on the function of the drive train so that it is more advantageous, according to new findings, to ensure that torque changes of this kind in the drive train are prevented during the intervention of stabilization systems.

The invention is therefore based on a method of controlling the mechanical drive train system of a motor vehicle having an automatic or automated transmission in conjunction with a stabilization system that acts on the wheels of the vehicle. The stabilization system comprises an electronic vehicle control device, which shifts the transmission depending on standard drive states detected by way of sensors and the stabilization system is controlled when non-standard driving states occur, whereby in the case of standard driving states and non-standard driving states different control programs are used for controlling the drive train.

In order to accomplish the set object, it is provided that if an intervention signal is present, indicating the occurrence of a non-standard drive state or a corresponding intervention by the stabilization system and, if the drive-train configuration is such that it would enable such intervention, all control measures that would modify the correct torque in the drive train and would thereby interfere with the intervention of the stabilization system, are prevented by the vehicle control device.

Accordingly, any action on the drive train that changes the torque presently prevailing therein in a manner that is disadvantageous for the intervention of the stabilization system is prevented if there is an intervention by the stabilization system. The precondition that a drive-train configuration must be present that would permit the intervention of the stabilization system is self-evident in terms of the invention, because the intervention would otherwise have no effect.

In order to ensure that this is the case, it is provided that if an intervention signal is present that indicates the occurrence of a non-standard drive state or an intervention by the stabilization system, the vehicle control device first checks whether or not the present drive-train configuration will permit the intended intervention by the stabilization system and that, if it does not, a drive-train configuration that will permit the intervention is first brought about by way of the vehicle control device.

For example, if the stabilization system tries to stabilize the vehicle by way of targeted intervention in the drive motor control system, but the drive train has been disconnected from the drive motor by releasing the vehicle clutch, which is to say the present state of the drive train does not allow intervention by the stabilization system, this situation is recognized by the vehicle control system, which then engages the clutch before intervention by the stabilization system takes place.

In order to optimize the drive train configuration for the intended intervention by the stabilization system, another embodiment of the invention provides for the vehicle control system to routinely check which elements interacting with the drive train are required for the intended intervention, and which are not required, and to then selectively connect the required elements to the drive train or disconnect the element that is not required.

According to the invention, the control measures that are to be prevented by the vehicle control device are the disengagement of the engaged drive train, the engaging of the disengaged drive train, and the activation of the auxiliary brakes and drives that act on the drive train. Auxiliary brakes shall be understood as retarders (primary retarders or secondary retarders), engine brakes, transmission brakes and the like. Auxiliary drives include starter engines and generators, as well as quite generally electric consumer loads whose electricity consumption is significant.

According to a preferred embodiment of the invention, the stabilization system comprises a superordinate control unit to which a plurality of control devices or control functions that act on the drive system of the vehicle are subordinated whereby, when there is an intervention by one of the subordinate control devices or a control function, an intervention signal is issued by the subordinate control device.

For example, if the vehicle is equipped with a EBS-control device, when an ABS-function is activated, the EBS-control device issues a signal such that the alternative control program, described above, is activated, which prevents control actions that lead to torque fluctuations in the drive train.

According to a special embodiment of the invention, it is provided that the superordinate control unit is a EBS-control device with which, at least one anti-locking function and one traction-slip control function, are associated.

According to another embodiment of the invention, a driving dynamics stabilization system is provided with which, in addition to an anti-locking function and a traction-slip control function, additional functions are associated, such as longitudinal, vertical or transversal dynamics stabilization.

Vehicles in the lower price ranges, with simple equipment, normally have only an ABS-control device as a stabilization system. According to a particularly simple embodiment of the invention, for these vehicles it is provided that in order to produce an intervention signal, the braking pressure development in the braking system is continuously detected and compared to a braking-pressure development pattern that is stored in the vehicle control device and typical for an intervention by an ABS-control device and that if there is at least approximate conformity between the current braking pressure development and the stored braking-pressure development pattern, a control measure that changes the present torque active in the drive train, for example a releasing of the clutch, is prevented by the vehicle control system.

### BRIEF DESCRIPTION OF THE DRAWINGS

The invention will now be described, by way of example, with reference to the accompanying drawings in which:

The sole FIGURE is a schematic representation of a block diagram of a drive train system for vehicles in which an embodiment of the present invention is realized.

### DETAILED DESCRIPTION OF THE INVENTION

The drive system of a vehicle, shown in FIGURE, comprises a drive motor 2, which is driveably connected to an automatic or automated transmission 6 via a motor output shaft 4, an input-side clutch 8 being associated with the transmission. A transmission output shaft 10 is driveably connected to drive wheels 14 via a differential transmission 12. The motor 2 with the motor output shaft 4 thereof the clutch 8 and the transmission 6 form, by definition, the drive train system.

The drive system depicted in the FIGURE also includes a stabilization system 16, which acts on brakes 24 of the drive wheels 14. The stabilizing system 16 is an ABS control device in the example shown.

The illustrated drive system is controlled by a vehicle control device 18. The vehicle control device 18 receives, as input signals, information on the position of a gas pedal 20, for example information on the operating state of the drive motor 2, the position of the clutch 8, the shifting state of the transmission 6 and on the position of a brake pedal 22 of the service brake. The drive motor 2, the clutch 8 and the transmission 6 are controlled and/or regulated via the vehicle control device 18.

As indicated above, the ABS-control device or the stabilization system 16 has a functional connection with the brakes 24, which are associated with the drive wheels 14, and can control the braking pressure of the brakes 24 individually in order to prevent the locking of the individual wheels.

The current braking pressure applied to the brakes 24 or the braking pressure development is detected by a braking-pressure development sensor 26 and reported to the vehicle control device 18. A braking-pressure development pattern is stored in the vehicle control device 18 that is typical of the activity of the ABS-control device or the stabilization system 16. If the braking-pressure development detected by the braking-pressure development sensor 26 at least approximately corresponds to the stored braking pressure development pattern, the alternative control program in the vehicle control device 18 is launched, which prevents any intervention that changes the torque in the drive train, for example the opening of the drive train system. It should be pointed out here that it is taken for granted that in such cases, the system cannot distinguish whether the ABS-control device is really active or whether the braking-pressure development detected was caused by other means, for example by the driver.

Additional areas of application are described below.

If a vehicle has a EBS-control device, this device reports with the source address thereof in the CAN (Controller Area Network) when an automatic stabilization system intervenes in the function of the vehicle brakes 24. Because the ABS-function is essentially a sub-function of the EBS-system, an ABS-control device does not report when there is ABS-braking action, but rather the EBS-control device reports on the CAN.

If the vehicle is equipped with a VDC-system (VDC=Vehicle Dynamic Stability Control), the “VDC information signal” can be used. This flag is set or this signal is produced when the VDC-system is active. If the VDS-system emits this signal, the vehicle is being stabilized. No distinction can be made between the VDC-system performing an ABS-braking operation or stabilizing longitudinal, vertical or transversal dynamics, however disengaging the drive train would be disadvantageous in any event.

The following additional signals should be reviewed before disengaging the drive train is initiated.
a) ROP (ROP=Roll Over Protection)—engine control active: if this mode is active, the driving dynamics stabilization system acts directly on the engine controller. The objective is the stabilization of the vehicle through a suitable change in the current torque in the drive train. If the drive train were disengaged in this situation, this intervention would have no effect.
b) ROP—Brake control active: if this mode is active, the driving dynamics stabilization system attempts to
   stabilize the vehicle by way of suitable braking intervention. Additional torque fluctuations in the drive train, as might occur, for example, with a transmission shift operation, could have an interferring effect. The disengagement of a closed drive train or an engaging drive train would have adverse effects in such a case.
c) YC (YC=Yaw Control)—engine control active: if this mode is active, the driving dynamics stabilization system acts on the
   engine controller. An attempt is made to prevent vehicle rotation about the vertical axis by an appropriate change in the current torque in the drive train. If the drive train were opened in this situation, this intervention would have no effect.
d) YC—Brake control active: if this mode is active, the driving dynamics stabilization system, by way of appropriate braking interventions, tries to prevent vehicle rotation about the vertical axis. Additional torque fluctuations in the drive train, as would occur with a transmission shifting operation, could have an interfering effect. The disengagement of an engaged drive train or the engagement of a disengaged drive train would be disadvantageous in this case.
e) Yaw rate: this signal indicates how much the vehicle has rotated about the vertical axis. If the signal development corresponds to defined patterns or the signal exceeds defined limit values, defined gradients and the like, it can be assumed that an intervention by the driving dynamics stabilization system is imminent or active. The disengagement of an engaged drive train or engaging a disengaged drive train would be disadvantageous in this case.
f) Transverse acceleration: this signal indicates the transverse acceleration of a vehicle. If the signal development corresponds to defined patterns or if it exceeds defined limit values, defined gradients and the like, it can be assumed that an intervention by a driving dynamics stabilization system is imminent or active. The disengagement of an engaged drive train or engaging of a disengaged drive train would be disadvantageous in this case.
g) Longitudinal acceleration: this signal indicates the longitudinal acceleration of a vehicle. If the signal development corresponds to defined patterns or the signal exceeds defined limit values, defined gradients and the like, it can be assumed that an intervention by a driving dynamics stabilization system is imminent or active. The disengagement of an engaged drive train or the engaging of a disengaged drive train would be disadvantageous in this case.

As explained above, the current torque in the drive train can also be influenced by auxiliary brakes or auxiliary drives. With an active driving dynamics stabilization system, auxiliary brakes, such as retarders (primary retarder or secondary retarder), engine brakes, transmission brakes and the like, are generally not activated. One exception occurs if the driving dynamics stabilization system demands an activation of auxiliary brakes in order to meet the stabilization objective.

Likewise, potentially existing auxiliary drives (for example, starter engines, generators, and the like) should generally not be activated when a driving dynamics stabilization system is active in order to prevent additional active torque in the drive train. There is also an exception to this, if activation of auxiliary drives can make a targeted impact on the current torque in the drive train. For example, electric motors that are driveably connected to the drive train generally act more spontaneously than combustion engines so they can bring about the desired changes in torque faster and more accurately than a combustion engine.

In general, if an intervention signal occurs, the vehicle control device (18) first checks whether a configuration of the drive train that would permit the intended intervention actually exists. If it does not, the vehicle control device must bring this configuration about before the intervention can take place whereby, in the manner described above, all control measures that would interfere with this intervention are prevented. It is also possible to optimize the drive train configuration with respect to the elements that are connected to it or disconnected from it, as described above.

### REFERENCE NUMERALS

2 drive motor
4 motor output shaft
6 transmission
8 clutch
10 transmission output shaft
12 differential transmission
14 drive wheels
16 stabilization system
18 vehicle control device
20 gas pedal
22 brake pedal
24 brakes
26 braking-pressure development sensor

1-18. (canceled)

19. A method of controlling a mechanical drive train (2, 4, 6, 8) of a motor vehicle having one of an automatic transmission (6) and an automated transmission (6) in combination with a stabilization system (16), which functions on wheels (14) of the vehicle, the stabilization system comprising an electronic vehicle control device (18) which shifts the transmission (6) as a function of standard driving states detected by sensors, and the stabilization system (16) being controlled, when a non-standard driving state is detected, with a different activation program being utilized to control the drive train for each of a detected standard driving state and a non-standard driving state, and all control actions that change a currently active torque in the drive train (2, 4, 6, 8) and interfere with the method by the stabilization system (16) are prevented by the vehicle control device (18), if an intervention signal indicates one of the non-standard driving state and an intervention by the stabilization system (16).

20. The method according to claim 19, further comprising the step of checking with the vehicle control device (18) whether a current drive train configuration will permit the intervention by the stabilization system, if a signal is present that indicates one of a non-standard drive state and an intervention by the stabilization system (16) and if the signal is not present engaging, the vehicle control device (18), the drive train in a configuration that will permit the intervention.

21. The method according to claim 20, further comprising the step of, if the elements are disconnected from the drive train (2, 4, 6, 8), engaging elements of the drive train that are required for the intended intervention.

22. The method according to claim 20, further comprising the step of if the elements are connected to the drive train (2, 4, 6, 8), disengaging elements of the drive train that are not required for the intended intervention.

23. The method according to claim 19, further comprising the step of including as control measures to be prevented by the vehicle control device (18): disengaging an engaged drive train (2, 4, 6, 8), engaging a disengaged drive train, and activating auxiliary brakes and auxiliary drives that act on the drive train.

24. The method according to claim 19, further comprising the step of providing the stabilization system with a superordinate control unit which controls at least one of a plurality of control devices and a plurality of control functions to manage the drive train of the motor vehicle such that an intervention signal is produced by the superordinate control device if an intervention by one of the subordinated control devices and one of the control functions occurs.

25. The method according to claim 24, further comprising the step of providing a EBS-control device, as the superordinate control unit, with which at least one anti-locking function and one traction-slip regulating function are associated.

26. The method according to claim 24, further comprising the step of providing a driving dynamics stabilization system, as the superordinate control unit, to control an anti-locking function, a traction-slip regulation function and at least one of longitudinal, vertical and transverse dynamics stabilization functions.

27. The method according to claim 19, further comprising the step of providing the stabilization system (16) with an ABS-control device, to continually detect and compare the development of braking-pressure in the braking system of the vehicle to a braking-pressure development pattern stored in the vehicle control device (18) and is typical of an intervention by the ABS-control device, and if at least approximate conformity exists between the current braking pressure development and the stored braking pressure development pattern, an intervention signal is produced for the vehicle control device (18) to prevent a change the current torque active in the drive train (2, 4, 6, 8).
